(19) United States
(12) Patent Application Publication
(10) Pub. No.: US 2007/0008850 A1
(43) Pub. Date: Jan. 11, 2007

(54) Apparatus and method of optically recording data

(76) Inventor: Yukihisa Nakajo, Yokohama-si (JP)

Correspondence Address: LEE & MORSE, P.C., 3141 FAIRVIEW PARK DRIVE, SUITE 500, FALLS CHURCH, VA, 22042, US

(21) Appl. No.: 11/481,188

(22) Filed: Jul. 6, 2006

(30) Foreign Application Priority Data
Jul. 6, 2005 (JP) 2005-197638
Feb. 10, 2006 (JP) 2006-34526

(51) Int. Cl. G11B 5/09

(52) U.S. Cl. 369/47.53; 369/59.11

(57) ABSTRACT

An apparatus and method for optically recording data may rapidly establish a high precision write strategy even when data is recorded at high speed. In the apparatus and method, test data including marks and spaces are recorded in an optical recording medium according to a predetermined write strategy. The recorded test data is read from the optical recording medium to produce a binary reproducing signal having mark pulses and spaces pulses corresponding to the marks and the spaces. A clock signal having a predetermined frequency is produced. Deviation values are detected between edge timing of the reproducing signal and the clock signal for edges of the respective marks of the reproducing signal. For each of the marks, the predetermined write strategy is compensated for, to equalize the deviation values.

### BACKGROUND OF THE INVENTION

1. Field of the Invention

The present invention relates to an optical data recording apparatus and a method of recording optical data. More particularly, the present invention relates to an optical data recording apparatus having an optimal write strategy for recording data in an optical recording medium, and a method of recording optical data using the optimal writing strategy.

2. Description of the Related Art

As new services such as the Internet have spread rapidly with the development of information and communication technologies, a large amount of data is continuously and actively being transmitted over networks. Meanwhile, in the field of data recording devices, one-time recordable optical disks such as CD-R or rewritable optical disks such as CD-RW are widely used. Recently, high-capacity optical disks, such as DVD-R, DVD-RW, and DVD-RAM, are being used in the data recording devices. These high-capacity optical disks use a thin substrate, an objective lens having a high numerical aperture (NA), thereby reducing spot diameter, and a short-wavelength light source, e.g., a semiconductor laser.

Data may be recorded in an optical disk by converting data received from an apparatus, e.g., a personal computer (PC), into an eight to fourteen modulation (EFM) signal. However, problems, e.g., pit forming failure, may occur when the heat accumulation or cooling speed of the optical disk is insufficient due to different composition ratios of a dye recording layer or other parts of the optical disk. In this case, marks or spaces may not be optimally formed on the optical disk, so that the EFM signal cannot be properly recorded.

Therefore, a characteristic recording parameter (hereinafter, referred to as a “write strategy”) may be set for each optical disk with respect to a reference recording waveform, so as to maintain an acceptable recording quality. However, it may be a heavy burden for a developer of a data recording device to determine a characteristic write strategy for each optical disk. Furthermore, it may be difficult to determine a characteristic write strategy for an optical disk introduced to the market after the optical recording device is already developed.

In accordance with a proposed solution, data may be recorded in an optical disk using a reference write strategy, and the length of each mark or space formed in the optical disk for recording the data may be measured by reading the recorded data. Then, a rising edge or a falling edge of a recording pulse corresponding to the mark or space may be adjusted to minimize the difference between the measured length and a theoretical length. In this way, an optimal write strategy may be automatically established. However, while the write strategy may adjust the recording length of, e.g., a mark, to be a theoretical length, the deviation of the leading edge or trailing edge of the mark is not considered. Therefore, the lengths of spaces located before and after the mark may deviate from theoretical lengths.

In accordance with another proposed solution, in addition to the deviation from the theoretical lengths, a front phase deviation value or a backside phase deviation value of each mark may be calculated to determine the deviation direction of a record length with respect to a theoretical length, and an optimal write strategy may be automatically established according to the determined deviation direction. However, it may take a relatively long time to calculate the deviation value for each mark and space. Furthermore, when the edge of a recording pulse is adjusted, only the edge of a mark corresponding to the recording pulse is considered. That is, effects on the edges of neighboring marks are not considered. Therefore, a precise write strategy cannot be established for short signal recording (for example, 3T or 4T signal recording) and/or high-speed recording for which thermal interference between marks and spaces may become problematic.

### SUMMARY OF THE INVENTION

The present invention is therefore directed to an apparatus and method of optically recording data, which substantially overcome one or more of the problems due to the limitations and disadvantages of the related art.

It is therefore a feature of an embodiment of the present invention to provide an apparatus and method of optically recording data including rapidly establishing a high precision write strategy even when data is recorded at high speed and/or using a short signal (for example, 3T and 4T).

It is therefore another feature of an embodiment of the present invention to provide an apparatus and method of accurately optically recording data by simply calculating deviation values of the rising and falling edges of marks and spaces.

At least one of the above and other features and advantages of the present invention may be realized by providing an optical data recording apparatus for recording data in an optical recording medium by forming rows of marks and spaces on the optical recording medium by generating recording pulse light in accordance with a predetermined write strategy and irradiating the recording pulse light to the optical recording medium. The optical data recording apparatus may include a test data recording unit recording test data including marks and spaces in the optical recording medium according to the predetermined write strategy, a reproduction signal generating unit reading the test data from the optical recording medium and generating a reproducing signal having mark pulses and spaces pulses corresponding to the marks and the spaces, a clock generating unit producing a clock having a predetermined frequency, a detecting unit detecting deviation values between edge timing of the reproducing signal and the clock for edges of the respective marks of the reproducing signal, and a compensation unit compensating for the predetermined write strategy for each of the marks to adjust the deviation values to the same value.

The optical data recording apparatus may further include a memory device storing a characteristic variation value of each edge of the marks, the characteristic variation value being a difference value between an edge of a reproducing signal obtained by reading test data recorded by an established write strategy and a corresponding edge of the reproducing signal obtained by reading the test data recorded by the predetermined write strategy, the established write strategy being prepared for slightly changing the edge timing of each mark pulse of the reproducing signal over the predetermined write strategy, wherein the compensation unit determines a compensation amount for the predetermined write strategy based on the characteristic variation value.

At least one of the above and other features and advantages of the present invention may be realized by providing a method of optically recording data in an optical recording medium by forming rows of marks and spaces on the optical recording medium by generating recording pulse light in accordance with a predetermined write strategy and irradiating the recording pulse light to the optical recording medium, the method including recording test data including marks and spaces in the optical recording medium according to the predetermined write strategy, reading the test data from the optical recording medium and generating a binary reproducing signal having mark pulses and spaces pulses corresponding to the marks and the spaces, producing a clock signal having a predetermined frequency, detecting deviation values between edge timing of the reproducing signal and the clock signal for determining edges of the respective marks of the reproducing signal, and compensating for the predetermined write strategy for each of the marks to adjust the deviation values so as to equal the same value.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates a block diagram of an optical data recording apparatus according to an embodiment of the present invention;

FIG. 2 illustrates a flowchart of a method of recording data according to a first embodiment of the present invention;

FIG. 3 illustrates a 3T mark when the falling edge of a 3T mark recording pulse is shifted by a predetermined length;

FIG. 4 illustrates the amounts by which the edges of a resulting mark are shifted with respect to the amount by which the falling edge of a 3T mark recording pulse is shifted;

FIG. 5 illustrates the relationship between a difference value and a characteristic compensation value;

FIG. 6 illustrates effects on a combination of a recorded 3T mark and a 3T space when the falling edge of a recording pulse of the 3T mark is shifted;

FIG. 7 illustrates effects when the amount by which the falling edge of a recording pulse of the 3T mark is shifted changes;

FIGS. 8A and 8B illustrate the relationship between a difference value and a characteristic compensation value according to another embodiment of the present invention;

FIG. 9 illustrates a flowchart of a method according to a second embodiment of the present invention;

FIG. 10 illustrates a bar graph comparing default, 2-edge, 3-edge, and 2-edge→3-edge write strategies at different write speeds and recording media, in terms of mark jitter;

FIG. 11 illustrates a bar graph comparing default, 2-edge, 3-edge, and 2-edge→3-edge write strategies at different write speeds and recording media, in terms of space jitter;

FIG. 12 illustrates a bar graph comparing default, 2-edge, 3-edge, and 2-edge→3-edge write strategies for different reference write strategies;

FIG. 13 illustrates a view explaining a method of adjusting a mark length and a space length individually;

FIG. 14 illustrates D2C deviations DLm and D™ of the leading and trailing edges of an mT mark;

FIG. 15 illustrates D2C deviations when a write strategy is established for combinations of marks and spaces;

FIG. 16 illustrates setting values of X and Y when D2C deviation values of marks and spaces recorded by WS-1 and WS-4 write strategies are two-dimensionally mapped;

FIG. 17 illustrates a two-dimensional map of D2C deviation distribution obtained using WS-1;

FIG. 18 illustrates a two-dimensional map of D2C deviation distribution obtained using WS-4;

FIG. 19 illustrates an enlarged view of a 3TM-3TS region of FIG. 17 having a desirable D2C deviation distribution;

FIG. 20 illustrates an enlarged view of a 3TM-3TS region of FIG. 18 having an undesirable D2C deviation distribution;

FIG. 21 illustrates a probability distribution table of mark-space combinations;

FIG. 22 illustrates distributions of marks located after 3TS;

FIG. 23 illustrates a flowchart for establishing an optimal write strategy using characteristic variation values stored in an optical recording apparatus in accordance with an embodiment of the present invention;

FIG. 24 illustrates a view for explaining general thermal interference deformation;

FIG. 25 illustrates a case where the leading and trailing edges of a recording pulse are shifted, and then the edges of a corresponding mark are measured;

FIG. 26 illustrates a bar graph comparing 3T, 4T, and 5T characteristic variations of various types of recording media at a wide range of recording speeds;

FIG. 27 illustrates characteristic variations of a leading edge when data is recorded in a DVD-R at a ×4 recording speed;

FIG. 28 illustrates characteristic variations of a trailing edge when data is recorded in a DVD-R at a ×4 recording speed;

FIG. 29 illustrates a plot comparing 3T characteristic variations when data is recorded at ×4 speed on DVD-Rs made by different manufacturers;

FIG. 30 illustrates a bar graph comparing 3T, 4T, and 5T characteristic variations when data is recorded at a ×4 recording speed on DVD-Rs made by different manufacturers;

FIG. 31 illustrates a plot of characteristic variations when data is recorded on the same CD-R at different recording speeds;

FIG. 32 illustrates a bar graph comparing characteristic variations when data is recorded on the same CD-R at different recording speeds;

FIG. 33 illustrates a bar graph comparing characteristic variations of the same optical disk when the optical disk is read by different RF signal compensation values;

FIG. 34 illustrates a plot of space jitter as a function of recording power for a CD-R (an optical disk-E) when data is recorded at a constant recording speed and a write strategy is automatically established with respect to the variation of the recording power;

FIG. 35 illustrates an mT mark-mT space combination;

FIG. 36 illustrates a plot of the relationship between the amount by which a pulse edge is shifted and D2C deviations of the leading and trailing edges of a 3T mark and the trailing edge of a 3T space for a 3T mark-3T space combination;

FIG. 37 illustrates a plot of the amount by which a pulse edge is shifted versus D2C deviations of the leading and trailing edges of a 4T mark and the trailing edge of a 4T space for a 4T mark-4T space combination;

FIG. 38 illustrates a plot of the amount by which a pulse edge is shifted versus D2C deviations of the leading and trailing edges of a 5T mark and the trailing edge of a 5T space for a 5T mark-5T space combination; and

FIG. 39 illustrates a bar graph obtained by calculating slopes of the linear approximation of the curves of FIGS. 36, 37, and 38, and dividing the slopes by 1T.

### DETAILED DESCRIPTION OF THE INVENTION

Japanese Patent Applications No. 2005-197638, filed on Jul. 6, 2005, and No. 2006-34526, filed on Feb. 10, 2006, in the Japanese Intellectual Property Office, and entitled: “Apparatus and Method of Optically Recording Data,” are incorporated by reference herein in their entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

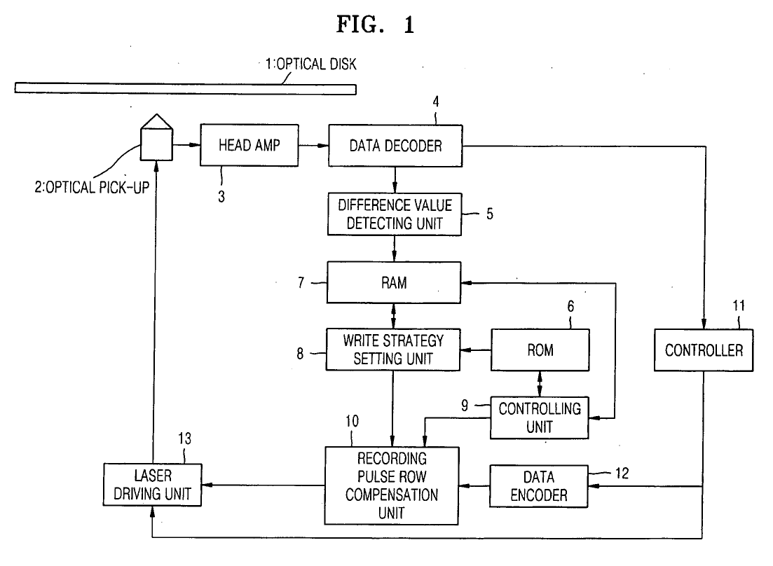

Before describing the particular problems to be solved by and solutions thereto in accordance with embodiments of the present invention, an optical data recording apparatus that may be used with an optical disk 1 (an optical recording medium) in accordance with embodiments of the present invention will now be described in detail with reference to FIG. 1.

Referring to FIG. 1, the optical data recording apparatus to be used with the optical disk 1 may include an optical pick-up 2, a head amp 3, a data decoder 4 (a reproduction signal generating unit, a clock signal generating unit), a difference value detecting unit 5 (a detecting unit), a ROM 6, a RAM 7, a write strategy setting unit 8 (a compensation unit), a controlling unit 9 (a test data recording unit), a recording pulse row compensation unit 10, a controller 11, a data encoder 12, and a laser driving unit 13.

The optical disk 1 may be an optical recoding medium for recording and reproducing data using a laser diode. Examples of the optical disk 1 include DVD±R.

Although not shown, the optical pick-up 2 may include a light source, e.g., a laser diode, optical components for directing and focusing light to and from the optical disk, and a photodetector (PD), e.g., a quadrant PD or a bisectional PD. The optical components may include a collimator lens, an object lens that may be actuated by a focusing actuator or tracking actuator, a polarizing beam splitter, and a cylindrical lens. The quadrant photodetector is divided into four sections A, B, C, and D and converts light into an electrical signal. Instead of or in addition to the PD, a front monitor diode may be included in the optical pick-up 2 for monitoring light output from the light source, e.g., when recorded data is being reproduced.

The head amp 3 may detect light reflected from the optical disk 1 and may calculate the amount of reflected light. The head amp 3 may generate a radio frequency (RF) signal indicating the sum of the amount of light reflected towards the respective sections of the PD, and may generate a focusing error (FE) signal by using an astigmatic aberration method of detecting a FE of light output by the optical pick-up 2. Furthermore, the head amp 3 may generate a tracking error (TE) signal by using a push pull method of detecting a TE of light output by the optical pick-up 2.

The data decoder 4 may generate a binary signal from the RF signal output by the head amp 3, and may convert the binary signal into a signal having a desired format, in order to send the converted signal to the controller 11. Furthermore, the data decoder 4 may extract a clock signal from the binary signal.

The difference value detecting unit 5 may receive the binary signal and the clock signal from the data decoder 4, and may detect difference values between the rising edges of the binary signal and edges of a theoretical pulse signal defined by the clock signal for each mark, and between the falling edges of the binary signal and edges of the theoretical pulse signal. These difference values correspond to the deviation values between the binary signal and the clock signal.

The ROM 6, i.e., a non-rewritable memory, may store a control program for controlling the overall operation of the optical data recording apparatus or a reference write strategy. Furthermore, the ROM 6 may store characteristic variation values of each mark. The characteristic variation values may be used to adjust the difference values to a constant value (described later in detail). The RAM 7, i.e., a rewritable memory, may temporarily store difference values detected for respective marks by the difference value detecting unit 5 and/or a write strategy set by the write strategy setting unit 8.

The write strategy setting unit 8 may adjust the difference values of each mark detected by the difference value detecting unit 5 to a constant value using compensation values, e.g., characteristic variation values, stored in the ROM 6, and the write strategy setting unit 8 may establish an optimal write strategy. Furthermore, the write strategy setting unit 8 may calculate deviations of edges when the reference write strategy is applied, and may calculate effects on an edge and its neighboring edges. The controlling unit 9 may control the overall operation of the optical data recording apparatus using the control program stored in the ROM 6.

The recording pulse row compensation unit 10 may receive a write strategy or parameters from the controlling unit 9 for forming a recording pulse row, and may send the recording pulse row to the laser driving unit 13. The controller 11 may transmit a recording signal to the data encoder 12, and may read a recoding signal from the data decoder 4. The data encoder 12 may convert the received recording signal into an eight to fourteen modulation (EFM) signal or other signals, and may send the converted signal to the recording pulse row compensation unit 10. The laser driving unit 13 may generate a laser driving pulse signal based on the received recording pulse signal, and may send the laser diode driving pulse signal to a light source (not shown) of the optical pick-up 2.

Now, specific embodiments for determining an optimum write strategy are discussed in detail below.

### Embodiment 1

A write strategy for recording data in an optical recording medium may be generally evaluated in terms of reproduction jitter. In one approach for reducing the reproduction jitter, a write strategy may be established for making lengths of marks and spaces formed on an optical recording medium approach theoretical lengths. In detail, data may be recorded on an optical recording medium by forming marks and spaces on the optical recording medium in accordance with a reference write strategy, and the recorded data may be read to measure the lengths of the recorded marks and spaces. Then, an optimal write strategy may be established by adjusting the width of each recording pulse to make the lengths of marks and spaces equal theoretical lengths.

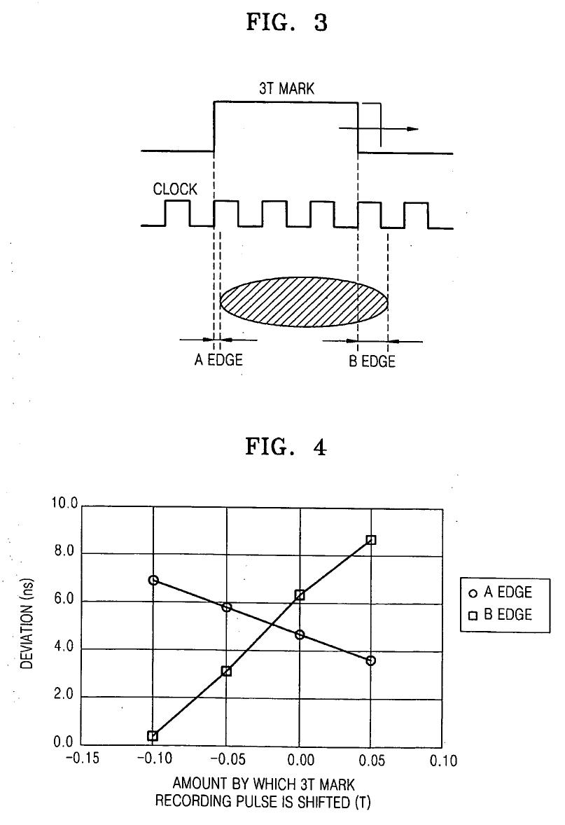

For example, as illustrated in FIG. 3, when the falling edge of a 3T mark recording pulse is shifted, one edge B of the resulting 3T mark corresponding to the falling edge of the 3T mark recording pulse is shifted. However, in this case, another edge A of the resulting 3T mark may also be affected. FIG. 4 illustrates the amounts by which the edges A and B of the resulting 3T mark may be shifted with respect to the amount by which the falling edge of the 3T mark recording pulse is shifted. Referring to FIG. 4, the amounts by which the edges A and B are shifted may be proportional to the amount by which the falling edge of the 3T mark recording pulse is shifted. As can be seen therein, the relationship may be approximately linear.

Even when the length of a recorded 3T mark is fit to a theoretical length by adjusting the width of a 3T mark recording pulse, neighboring spaces are affected by the adjustment of the 3T mark recording pulse, since the adjustment of the recording pulse affects both edges of the 3T mark. Therefore, the overall reproduction jitter may not be improved. For this reason, when one edge of a mark recording pulse is adjusted, one edge of the resulting mark corresponding to the adjusted edge of the mark recording pulse and the other edge of the resulting mark may be considered as well.

Accordingly, in accordance with a first embodiment of the present invention, a clock signal extracted from a reproducing signal may be used to detect deviation values of pulses of a reproducing pulse signal corresponding to recorded marks in order to determine how much both edges of the recorded mark are spaced apart from desired positions. In addition, for example, one of the rising edge and falling edge of a 3T mark recording pulse may be shifted by a predetermined length, and then the characteristic variation of the resulting 3T mark, e.g., how much both edges of the resulting 3T mark are spaced apart from desired positions, may be used to adjust the deviation values to a constant value. In detail, the write strategy may be compensated for by shifting edge timing of all marks and spaces to uniformly deviate edges of all the marks and spaces with respect to a clock signal. In this way, the write strategy may be optimized.

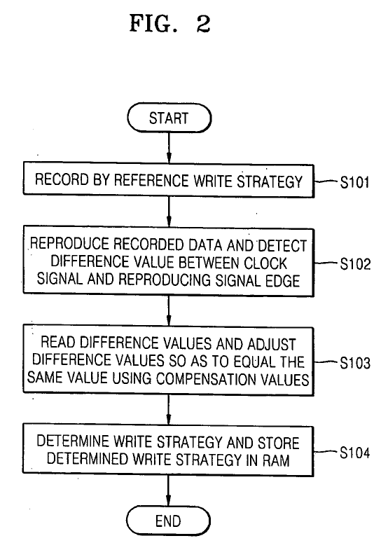

A method of optically recording data will now be described in accordance with the first embodiment of the present invention with reference to FIG. 2.

In operation S101, the controlling unit 9 may read parameters related to a reference write strategy from the ROM 6, and may set the recording pulse row compensation unit 10 using the read parameters. The recording pulse compensation unit 10 may establish the reference write strategy according to the set parameters and sends the established reference write strategy to the laser driving unit 13. The laser driving unit 13 may generate a laser driving pulse signal corresponding to a recording pulse signal based on the reference write strategy, and may send the laser driving pulse signal to the light source (not shown) of the optical pick-up 2 for recording marks and spaces in a test recording area of the optical disk 1.

In operation S 102, after the marks and spaces are completely recorded, the controlling unit 9 may move the optical pick-up 2 to a recording track in the test recording area of the optical disk 1, and may generate a reproducing signal by scanning the recorded marks and spaces. The reproducing signal may be sent from the optical pick-up 2 to the data decoder 4 through the head amp 3. The data decoder 4 may generate a binary signal using the reproducing signal, and may extract a clock signal from the binary signal. The binary signal and the clock signal may be sent from the data decoder 4 to the difference value detecting unit 5. The difference value detecting unit 5 may detect difference values between the binary signal (a reproducing pulse signal corresponding to each mark, e.g., 3T, 4T, and 5T marks) and a theoretical pulse signal (defined by the clock signal and corresponding to a theoretical length of each mark). The detected difference values may be stored in the RAM 7.

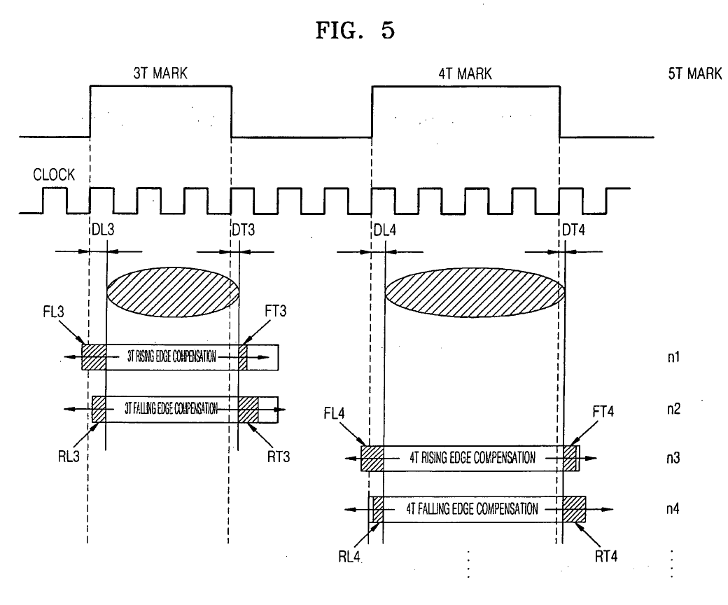

In operation S 103, the write strategy setting unit 8 may read the difference values (for example, DL3, DT3, DL4, DT4 in FIG. 5) from the RAM 7. The write strategy setting unit 8 may read characteristic variation values of each mark from the ROM 6. The characteristic variation values may include first amounts by which both edges of a reproducing pulse are shifted when the rising edge of a corresponding recording pulse is shifted by a minimal controllable resolution length and second amounts by which both edges of the reproducing pulse are shifted when the falling edge of the corresponding recording pulse is shifted by a minimal controllable resolution length. For example, FL3 and FT3 in FIG. 5 are first amounts by which both edges of a 3T mark reproducing pulse may be shifted when the rising edge of a corresponding 3T mark recording pulse is shifted (FL4 and FT4 are for 4T mark and so on). Furthermore, RL3 and RT3 in FIG. 5 are second amounts by which both edges of the 3T mark reproducing pulse may be shifted when the falling edge of the corresponding 3T mark recording pulse is shifted (RL4 and RT4 are for 4T mark and so on).

Then, using the characteristic variation values, the following simultaneous equations, Equation 1, may be solved to obtain compensation values for n1, n2, n3, n4, . . . that modify the difference values such as DL3, DT3, DL4, and DT4 (obtained from the difference between the reproducing pulse signal corresponding to each mark and the theoretical pulse signal defined by the clock signal and corresponding to a theoretical length of each mark) to equal the same value (k).
DL3−(FL3*n1+RL3*n2)=k
DT3−(FT3*n1+RT3*n2)=k
DL4−(FL4*n3+RL4*n4)=k
DT4−(FT4*n3+RT4*n4)=k [Equation 1]

When thermal interferences from neighboring marks are negligible, only the corresponding edge of a reproducing pulse to a shifted edge of a recording pulse may be considered to obtain the compensation values n1, n2, n3, n4, . . . as shown in the following simultaneous equations, Equation 2:
DL3−FL3*n1=k
DT3−RT3*n2=k
DL4−FL4*n3=k
DT4−RT4*n4=k [Equation 2]

In operation S 104, the calculated values n1, n2, n3, n4, . . . may be used to adjust the rising and falling edges of a mark recording pulse signal of the reference write strategy. The reference write strategy may be thus adjusted, and the adjusted write strategy may be stored in the RAM 7. Then, the recording of marks and spaces may be performed according to the stored write strategy.

Although the first embodiment uses stored characteristic variation values (e.g., the amounts by which both edges of a reproducing pulse are shifted when only one of the rising and falling edges of a corresponding recording pulse is shifted by a minimal controllable resolution length), such characteristic variation values may instead be directly determined by recording marks in the optical recording medium and evaluating the resulting reproducing signal.

As explained above, when an edge of a mark recording pulse is shifted, difference values between edges of a reproducing pulse of the resulting mark and a clock signal may be calculated for each mark. Next, an optimal write strategy may be established by solving the simultaneous equations, which are prepared for obtaining values that modify the difference values to the same value using the characteristic variation values of each mark. Therefore, a high-precision write strategy may be rapidly established.

### Embodiment 2

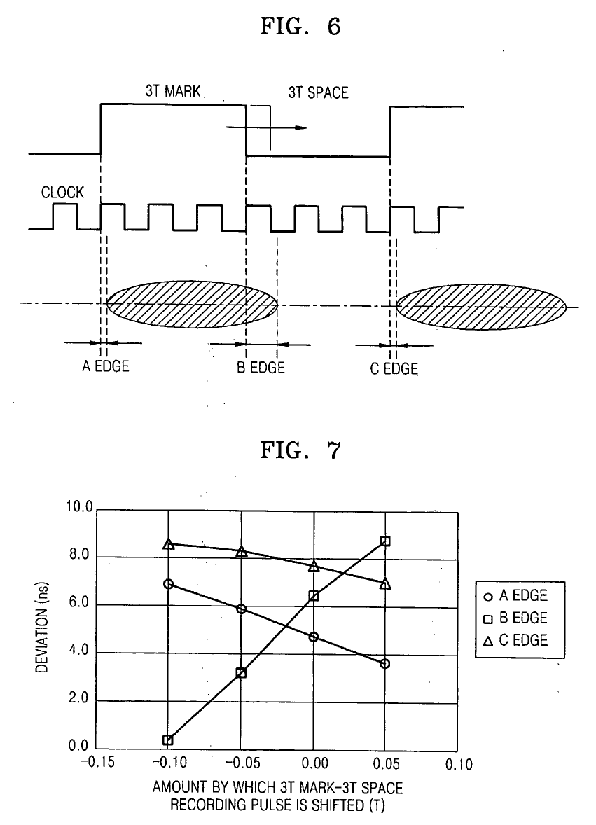

The first embodiment discusses the resulting effects on the rising and falling edges of a reproducing pulse of a mark when the rising edge or falling edge of a recording pulse of the mark is shifted by a predetermined length. However, as illustrated in FIG. 6, when the rising edge or failing edge of the recording pulse is shifted, neighboring marks may also be affected, as well as the rising and falling edges of the resulting reproducing pulse.

FIG. 6 illustrates effects on a combination of a recorded 3T mark and a 3T space when the falling edge of a recording pulse of the 3T mark is shifted. Referring to FIG. 6, shifting the falling edge of the recording pulse of the 3T mark may have an effect on an edge C of a neighboring mark spaced apart from the 3T mark by the 3T space as well as on both edges A and B of the 3T mark.

FIG. 7 illustrates the amounts by which the edges A, B, and C may be shifted with respect to the amount by which the falling edge of the recording pulse of the 3T mark is shifted. Referring to FIG. 7, the edges A, B, and C may be shifted in proportion to the shifting of the falling edge of the recording pulse. As can be seen therein, the relationship is substantially linear.

Therefore, a combination of a mark and a space may be considered, instead of considering only the mark, to establish a more precise write strategy. For this reason, in a second embodiment of the present invention, adjustment may be performed on the combination of a mark and a space.

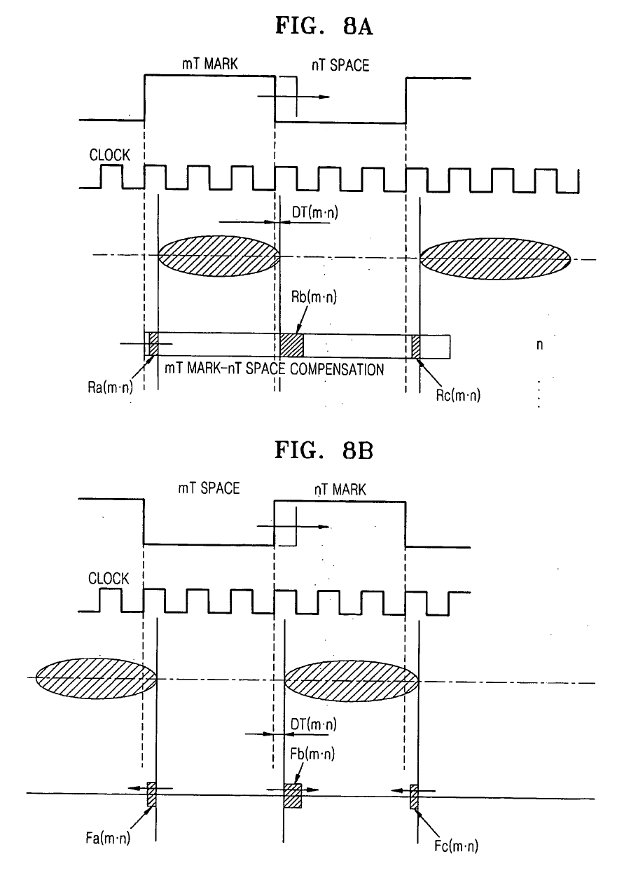

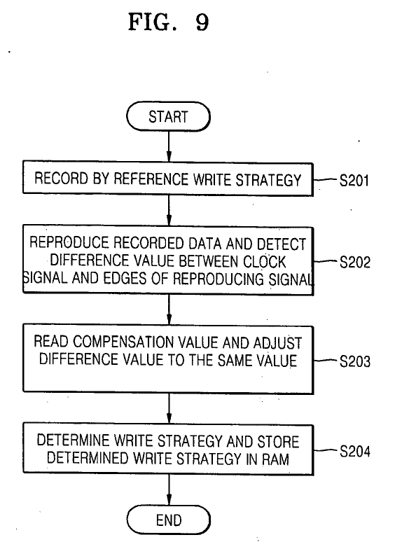

A method of optically recording data in accordance with the second embodiment of the present invention will now be described in detail with reference to FIGS. 8A, 8B and 9. The optical data recording apparatus of the second embodiment may have the same structure as the optical data recording apparatus illustrated in FIG. 1, however, specific elements therein may function differently than for the first embodiment. For example, in order to establish a write strategy using a combination of a mark and a space, the difference value detecting unit 5 may detect difference values for a mark/space combination, the next space/mark combination, and so on. Furthermore, the ROM 6 may store compensation values used for modifying the difference values detected by the difference value detecting unit 5 to all be the same value, and the RAM 7 may temporarily store the difference values detected by the difference value detecting unit 5 and/or a write strategy set by the write strategy setting unit 8.

As illustrated in FIG. 9, in operation S 201, the controlling unit 9 may read parameters related to a reference write strategy from the ROM 6 and may set the recording pulse row compensation unit 10 using the read parameters. The recording pulse compensation unit 10 may establish the reference write strategy according to the set parameters, and may send the established reference write strategy to the laser driving unit 13. The laser driving unit 13 may generate a laser driving pulse signal corresponding to a recording pulse signal based on the reference write strategy, and may send the laser driving pulse signal to a light source (not shown) of the optical pick-up 2 for recording marks and spaces in a test recording area of the optical disk 1.

In operation S 202, after the marks and spaces are completely recorded, the controlling unit 9 may move the optical pick-up 2 to a recording track in the test recording area of the optical disk 1, and may generate a reproducing signal by scanning the recorded marks and spaces. The reproducing signal may be sent from the optical pick-up 2 to the data decoder 4 through the head amp 3. The data decoder 4 may generate a binary signal using the reproducing signal, and may extract a clock signal from the binary signal. The binary signal and the clock signal may be sent from the data decoder 4 to the difference value detecting unit 5. The difference value detecting unit 5 may detect difference values between the binary signal (a reproducing pulse signal corresponding to each mark, such as 3T, 4T, and 5T marks) and a theoretical pulse signal (defined by the clock signal and corresponding to a theoretical length of each mark). The detected difference values may be stored in the RAM 7.

In operation S 203, the write strategy setting unit 8 may read the difference values (for example, DL(m, n) in FIG. 8A) detected by the difference value detecting unit 5 and stored in the RAM 7. Furthermore, the write strategy setting unit 8 may read characteristic variation values of each combination of a mark and a space from the ROM 6. For example, the characteristic variation values may include first amounts (e.g., Ra(m, n), Rb(m, n), and Rc(m, n) in FIG. 8A) by which edges of a reproducing pulse signal of the combination of mT mark and nT space are shifted when the falling edge of a corresponding recording pulse is shifted by a minimal controllable resolution length, and second amounts (Fa(m, n), Fb(m, n), and Fc(m, n) in FIG. 8B) by which edges of the reproducing pulse signal of the combination of mT mark and nT space are shifted when the rising edge of a nT mark recording pulse is shifted by a minimal controllable resolution length.

Then, based on the characteristic variation values, simultaneous equations may be prepared as in the first embodiment to modify the difference values to equal the same value (k), and the simultaneous equations are solved to obtain compensation values n1, n2, n3, n4, . . . When thermal interferences from neighboring marks are negligible, only Rb(m, n) and Fb(m, n) can be used to calculate n1, n2, n3, n4, . . . used for adjusting the difference values between the clock edges and mark/space edges to the same value (k), i.e., Equation 2 may be used.

In operation S 204, the compensation values n1, n2, n3, n4, . . . may be used to adjust the rising and falling edges of a mark recording pulse signal of the reference write strategy. The reference write strategy may be adjusted in this way, and the adjusted write strategy may be stored in the RAM 7. Then, recording of marks and spaces may be performed according to the stored write strategy.

Although the second embodiment uses stored characteristic variation values (e.g., the amounts by which reproducing pulses of a combination of a mark and a space are shifted when only one of the rising and falling edges of a recording pulse of the mark is shifted by a minimal resolution length), such characteristic variation values may be directly determined by recording marks and spaces in the optical recording medium and evaluating the resulting reproducing signal.

As explained above, in the second embodiment, adjustment may be performed on the combination of a mark and a space, so that a high-precision write strategy may be rapidly established.

[Implementation]

Various implementations for determining write strategies using the first and/or second embodiments of the present invention, as well as comparative advantages thereof, will now be described in detail.

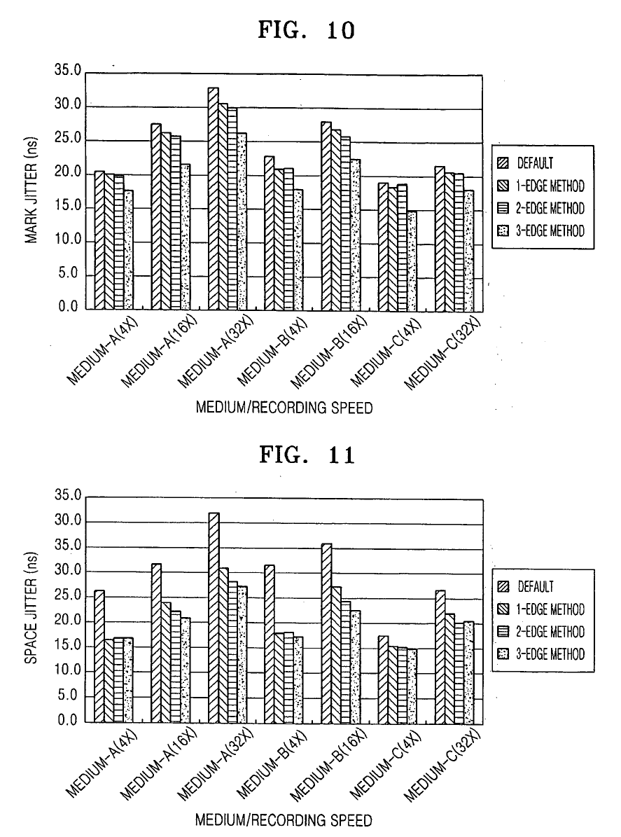

FIGS. 10 and 11 illustrate the effects of embodiments of the present invention. FIG. 10 illustrates mark jitter and FIG. 11 illustrates space jitter as a function of the recording speed of various CD-R media for different write strategies. In FIGS. 10 and 11, default, 1-edge method, 2-edge method, and 3-edge method denote the type of write strategies. The default write strategy may be, e.g., a (n-k)T write strategy. In the default write strategy, compensation is not performed for a mark, a space, or a combination of a mark and a space. In the 1-edge write strategy, the rising edge or the falling edge of a recording pulse of a predetermined mark may be adjusted, and then the resulting effect observed only from a corresponding edge of a reproducing pulse of the mark is reflected in the write strategy. The 2-edge write strategy corresponds to the write strategy in accordance with the first embodiment of the present invention, described with reference to FIG. 2. The 3-edge write strategy corresponds to the write strategy in accordance with the second embodiment of the present invention, described with reference to FIG. 9.

Referring to FIGS. 10 and 11, the 1-edge, 2-edge, and 3-edge write strategies reduce both mark and space jitter as compared with the default write strategy. In particular, mark and space jitter are more significantly reduced at higher recording speeds. The 3-edge write strategy exhibits the most effective performance.

However, other test results illustrate that when a reference write strategy is changed, compensation by the 3-edge write strategy does not always provide optimal results. FIG. 12 illustrates jitter (%) with respect to four reference write strategies (WS-1, WS-2, WS-3, and WS-4) for default, 2-edge, 3-edge, and 2-edge→3-edge (3-edge write strategy performed after 2-edge write strategy) write strategies.

Referring to FIG. 12, effects of the respective write strategies are compared while changing the reference write strategy. When a reference write strategy resulting in a low recording quality is used, the 2-edge write strategy is effective. When a reference write strategy resulting in a high recording quality is used, the 3-edge write strategy is effective. Therefore, it can be determined whether the 3-edge write strategy is used alone or together with the 2-edge write strategy (2-edge→3-edge) depending on the efficiency of the reference write strategy.

Generally, in the 2-edge write strategy, the adjustment of the rising and falling edges of a recording pulse may be performed for each type of mark. Therefore, although very precise recording cannot be performed by the 2-edge write strategy, it can effectively perform recording to some degree when the reference write strategy is poor. In the 3-edge write strategy, adjustment is precisely performed for each combination of a mark and a space. Therefore, the 3-edge write strategy is very effective when the reference write strategy is good, although the efficiency of the 3-edge write strategy decreases when the reference write strategy is poor.

In this manner, use of the 3-edge write strategy is used alone or together with the 2-edge write strategy (2-edge→3-edge) may be determined by evaluating the recording quality of test data recorded by a reference write strategy.

In the 2-edge and 3-edge write strategy, a particular edge of a recording pulse or a combination of several edges of a recording pulse signal may be adjusted. In the 1-edge write strategy, the lengths of a mark and a space are simply adjusted to reference lengths. In detail, in the 1-edge write strategy, the mean length of all types of marks and spaces are measured, and the rising edge or the falling edge of a recording pulse is shifted based on the deviation from reference lengths, thereby conforming the lengths of marks and spaces to the reference lengths.

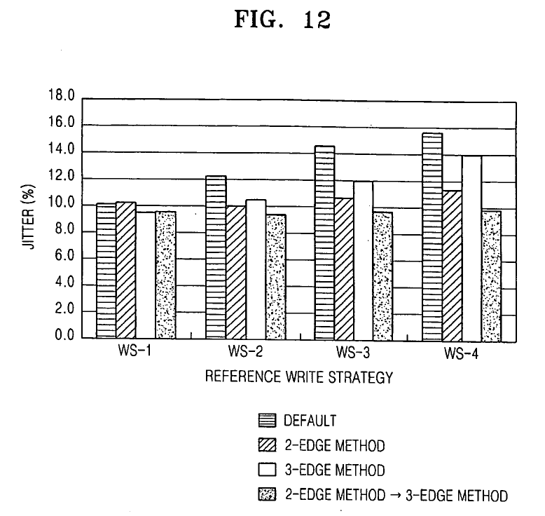

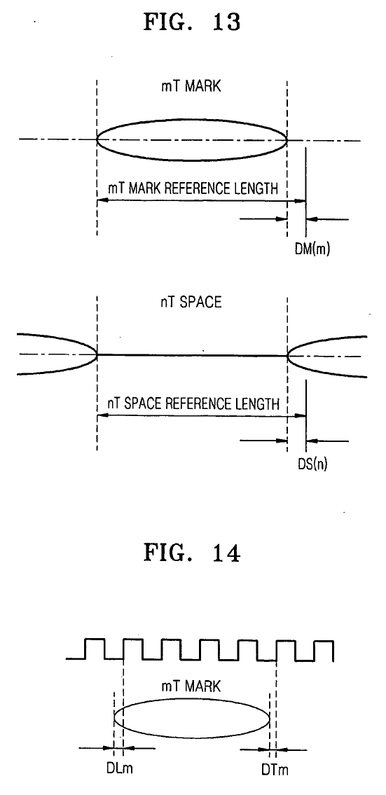

For example, as illustrated in FIG. 13, when the deviation of the lengths of a mT mark and a nT space from reference lengths are DM(m) and DS(n), respectively, and the characteristic variation values of the trailing edges of the mT mark and the nT space are aM(m) and aS(n), respectively, compensation values for the trailing edges of the mT Mark and nT space are DM(m)/aM(m) and DS(n)/aS(n), respectively. Although the compensation is performed on the trailing edges of the mT mark and nT space in FIG. 13, the compensation can be performed on the leading edges of the mT mark and nT space in the same way using the characteristic variation values of the leading edges.

Although the mark length and the space length are individually adjusted, i.e., the effect of the adjustment of the mark is not reflected in the adjustment of the space, and vice versa, the 1-edge write strategy is simple. Furthermore, the 1-edge write strategy is effective when the reference write strategy does not provide good recording quality. Therefore, the use of the 1-edge write strategy together with the 2-edge and 3-edge write strategies may provide the optimal performance/requirement combination. For example, └1-edge write strategy→3-edge write strategy┘ and └1-edge write strategy→2-edge write strategy→3-edge write strategy┘.

When the 2-edge write strategy is used, optimal compensation values may be easily obtained as follows. Referring to FIG. 14, when data to clock signal deviations (D2Cs) of the leading and trailing edges of a mT mark are DLm and DTm, the characteristic variation value of the leading edge of the mT mark is RLm, the characteristic variation value of the trailing edge of the mT mark is RTm, a compensation value for the leading edge of the mT mark is n(2m−5), and a compensation value for the trailing edge of the mT mark is n(2m−4), the following Equation 3 may be obtained:
DLm=FLm*n(2m−5)+RLm*n(2m−4)+k
DTm=FTm*n(2m−5)+RTm*n(2m−4)+k [Equation 3]

where k is a fixed value (a weighted average of DLm and DTm).

When the same equation is applied to all marks, the following matrix Equation 4 may be obtained.

$$[ \begin{matrix}{DL}_{3} \\ {DL}_{4} \\ {DL}_{5} \\ ⋮ \\ ⋮ \\ {DL}_{14} \\ {DT}_{3} \\ {DT}_{4} \\ {DT}_{5} \\ ⋮ \\ ⋮ \\ {DT}_{14}\end{matrix} ] - K = [ \begin{matrix}{FL}_{3} & 0 & 0 & ⋯ & ⋯ & 0 & {RL}_{3} & 0 & 0 & ⋯ & ⋯ & 0 \\ 0 & {FL}_{4} & 0 & ⋯ & ⋯ & 0 & 0 & {RL}_{4} & 0 & ⋯ & ⋯ & 0 \\ 0 & 0 & {FL}_{5} & ⋯ & ⋯ & 0 & 0 & 0 & {RL}_{5} & ⋯ & ⋯ & 0 \\ ⋮ & ⋯ & ⋯ & ⋯ & ⋯ & ⋯ & ⋯ & ⋯ & ⋯ & ⋯ & ⋯ & ⋮ \\ ⋮ & ⋯ & ⋯ & ⋯ & ⋯ & ⋯ & ⋯ & ⋯ & ⋯ & ⋯ & ⋯ & ⋮ \\ 0 & 0 & 0 & ⋯ & ⋯ & {FL}_{14} & 0 & 0 & 0 & ⋯ & ⋯ & {RL}_{14} \\ {FT}_{3} & 0 & 0 & ⋯ & ⋯ & 0 & {RT}_{3} & 0 & 0 & ⋯ & ⋯ & 0 \\ 0 & {FT}_{4} & 0 & ⋯ & ⋯ & 0 & 0 & {RT}_{4} & 0 & ⋯ & ⋯ & 0 \\ 0 & 0 & {FT}_{5} & ⋯ & ⋯ & 0 & 0 & 0 & {RT}_{5} & ⋯ & ⋯ & 0 \\ ⋮ & ⋯ & ⋯ & ⋯ & ⋯ & ⋯ & ⋯ & ⋯ & ⋯ & ⋯ & ⋯ & ⋮ \\ ⋮ & ⋯ & ⋯ & ⋯ & ⋯ & ⋯ & ⋯ & ⋯ & ⋯ & ⋯ & ⋯ & ⋮ \\ 0 & 0 & 0 & ⋯ & ⋯ & {FT}_{14} & 0 & 0 & 0 & ⋯ & ⋯ & {RT}_{14}\end{matrix} ] [ \begin{matrix}{n}_{1} \\ {n}_{3} \\ {n}_{5} \\ ⋮ \\ ⋮ \\ {n}_{23} \\ {n}_{2} \\ {n}_{4} \\ {n}_{6} \\ ⋮ \\ ⋮ \\ {n}_{24}\end{matrix} ] \qquad [ Equation 4 ]$$

Equation 4 is a general form of the Equation 1 described in operation S 103 of FIG. 2. The values n₁, n₃, . . . n₂₃, n₂, n₄, . . . n₂₄ may be easily calculated using the inverse matrix. When the effects of neighboring mark rows are low (negligible), RL₃ through RL₁₄ and FT₃ through FT₁₄ may be set to zero, i.e., a general form of the Equation 2 may be used.

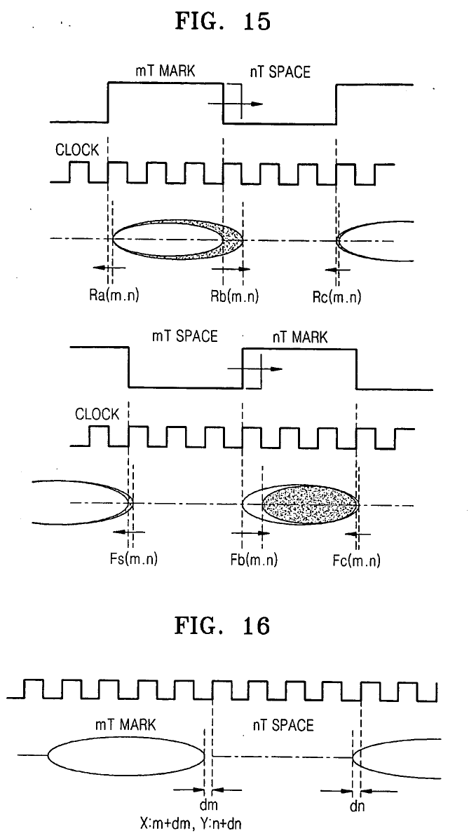

FIG. 15 illustrates a view explaining the 3-edge write strategy, and the above-described method of calculating the compensation values can be applied to the 3-edge write strategy in a similar manner. First, the characteristic variation values may be determined as illustrated in FIG. 15. When DT(m, n) is the D2C deviation in mT mark-nT space and DL(m, n) is the D2C deviation in mT space-nT mark, the compensation values nL(m, n) and nT(m, n) may be calculated by the following Equation 5.

$$DL ( m , n ) - k = Fb ( m , n ) * nL ( m , n ) + {\sum }_{i = 3}^{14} [ Ra ( i , m ) * RT ( i ) * nT ( i , m ) ] + {\sum }_{j = 3}^{14} [ Rc ( n , j ) * RT ( j ) * nT ( n , j ) ] \\ DT ( m , n ) - k = Rb ( m , n ) * nT ( m , n ) + {\sum }_{i = 3}^{14} [ Fa ( i , m ) * RL ( i ) * nL ( i , m ) ] + {\sum }_{j = 3}^{14} [ Fc ( n , j ) * RL ( j ) * nL ( n , j ) ] \qquad [ Equation 5 ]$$

where RT(i) is the probability of the existence of iT mark, and RL(i) is the probability of the existence of iT space.

When Equation 5 is applied to all combinations of marks and spaces, the following matrix Equation 6 may be obtained like in the case of the Equation 4. The solutions of the Equation 6 may be easily calculated using the inverse matrix.

$$[ \begin{matrix}{DL}_{3 , 3} \\ {DL}_{3 , 4} \\ {DL}_{3 , 5} \\ ⋮ \\ ⋮ \\ {DL}_{14 , 14} \\ {DT}_{3 , 3} \\ {DT}_{3 , 4} \\ {DT}_{3 , 5} \\ ⋮ \\ ⋮ \\ {DT}_{14 , 14}\end{matrix} ] - K = [ \begin{matrix}{Fb}_{3 , 3} & 0 & 0 & ⋯ & ⋯ & 0 & {p}_{3 , 3} & {p}_{3 , 4} & {p}_{3 , 5} & ⋯ & ⋯ & {p}_{3 , 14} \\ 0 & {Fb}_{3 , 4} & 0 & ⋯ & ⋯ & 0 & {p}_{4 , 3} & {p}_{4 , 4} & {p}_{4 , 5} & ⋯ & ⋯ & {p}_{4 , 14} \\ 0 & 0 & {Fb}_{3 , 5} & ⋯ & ⋯ & 0 & {p}_{5 , 3} & {p}_{5 , 4} & {p}_{5 , 5} & ⋯ & ⋯ & {p}_{5 , 14} \\ ⋮ & ⋯ & ⋯ & ⋯ & ⋯ & ⋯ & ⋯ & ⋯ & ⋯ & ⋯ & ⋯ & ⋮ \\ ⋮ & ⋯ & ⋯ & ⋯ & ⋯ & ⋯ & ⋯ & ⋯ & ⋯ & ⋯ & ⋯ & ⋮ \\ 0 & 0 & 0 & ⋯ & ⋯ & {Fb}_{14 , 14} & {p}_{14 , 3} & {p}_{14 , 4} & {p}_{14 , 5} & ⋯ & ⋯ & {p}_{14 , 14} \\ {q}_{3 , 3} & {q}_{3 , 4} & {q}_{3 , 5} & ⋯ & ⋯ & {q}_{3 , 14} & {Rb}_{3 , 3} & 0 & 0 & ⋯ & ⋯ & 0 \\ {q}_{4 , 3} & {q}_{4 , 4} & {q}_{4 , 5} & ⋯ & ⋯ & {q}_{4 , 14} & 0 & {Rb}_{3 , 4} & 0 & ⋯ & ⋯ & 0 \\ {q}_{5 , 3} & {q}_{5 , 4} & {q}_{5 , 5} & ⋯ & ⋯ & {q}_{5 , 14} & 0 & 0 & {Rb}_{3 , 5} & ⋯ & ⋯ & 0 \\ ⋮ & ⋯ & ⋯ & ⋯ & ⋯ & ⋯ & ⋯ & ⋯ & ⋯ & ⋯ & ⋯ & ⋮ \\ ⋮ & ⋯ & ⋯ & ⋯ & ⋯ & ⋯ & ⋯ & ⋯ & ⋯ & ⋯ & ⋯ & ⋮ \\ {q}_{14 , 3} & {q}_{14 , 4} & {q}_{14 , 5} & ⋯ & ⋯ & {q}_{14 , 14} & 0 & 0 & 0 & ⋯ & ⋯ & {RT}_{14 , 14}\end{matrix} ] [ \begin{matrix}{nL}_{3 , 3} \\ {nL}_{3 , 4} \\ {nL}_{3 , 5} \\ ⋮ \\ ⋮ \\ {nL}_{14 , 14} \\ {nT}_{3 , 3} \\ {nT}_{3 , 4} \\ {nT}_{3 , 5} \\ ⋮ \\ ⋮ \\ {nT}_{14 , 14}\end{matrix} ] \qquad [ Equation 6 ]$$

where p_{3,3} through p_{14,14} and q_{3,3} through q_{14,14} are coefficients of Σ. When the effects of neighboring edges are low (negligible), p and q may be set to zero.

Next, a method of selecting between four write strategies illustrated in FIG. 12 and determining the order of write strategies will now be described. A signal sample ratio may be measured from data recorded by a reference write strategy, and which write strategies were used and in which order the write strategies were used may be determined based on the measured sample ratio.

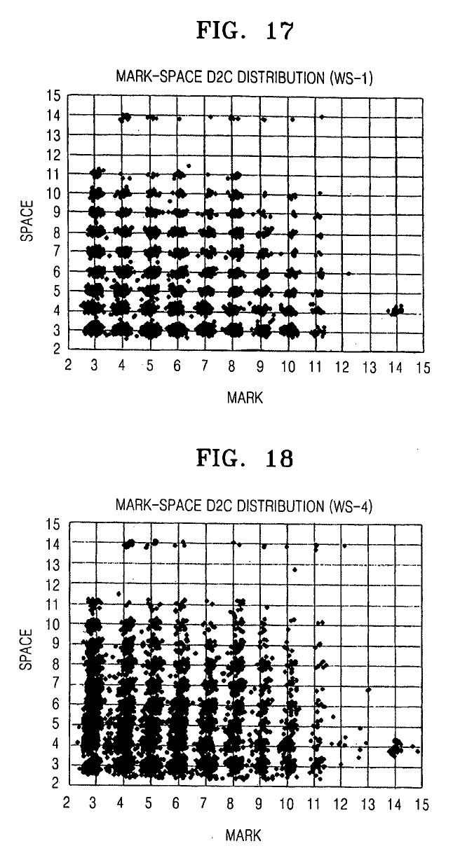

FIG. 17 illustrates a two-dimensional mapping result of D2C deviations of marks and spaces recorded by WS-1 selected from among four reference write strategies (WS-1, WS-2, WS-3, and WS-4) illustrated in FIG. 12, and FIG. 18 illustrates the same mapping graph obtained using WS-4. X and Y may set as illustrated in FIG. 16, i.e., deviation X of mT mark is m+dm and deviation Y of nT space is n+dn.

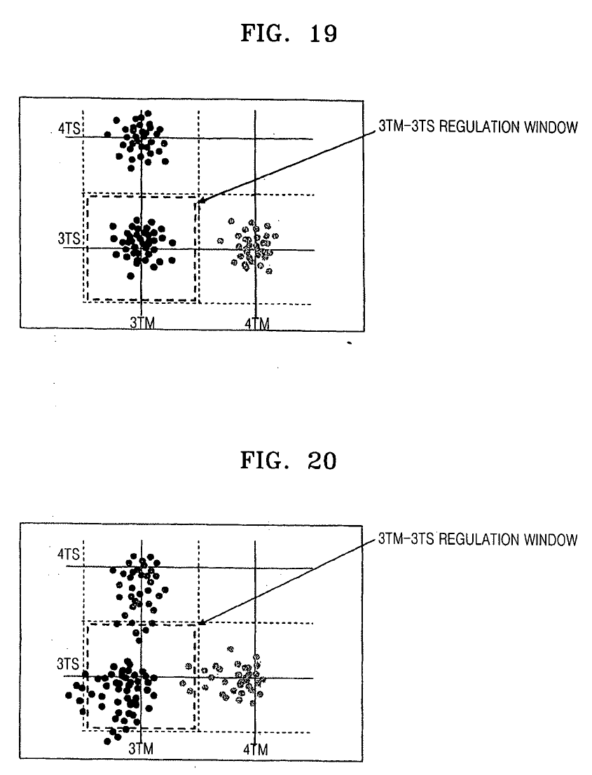

Referring to FIGS. 17 and 18, the distribution by WS-4 is more scattered than the distribution by WS-1. FIG. 19 illustrates an enlarged view of a 3TM-3TS region of FIG. 17 and FIG. 20 illustrates an enlarged view of a 3TM-3TS region of FIG. 18. As illustrated in FIG. 19, when data is recorded at a high quality, e.g., using a good reference write strategy such as WS-1, most of the data is within a regulation range, i.e., a regulation window. Meanwhile, as illustrated in FIG. 20, when the recording quality is not good, e.g., using a good reference write strategy such as WS-4, some of the recorded data is outside of the regulation range and other data is partially within the regulation range.

Thus, for poor write strategies, using the average value of the recorded data distribution may be inconsistent with the average value of a standard regulation range distribution. Therefore, when a write strategy is optimized using a mark-space combination based on this average value, a high-precision setting cannot be obtained. Thus, it must be determined whether sampled mark-space combination data is suitable for establishing a write strategy.

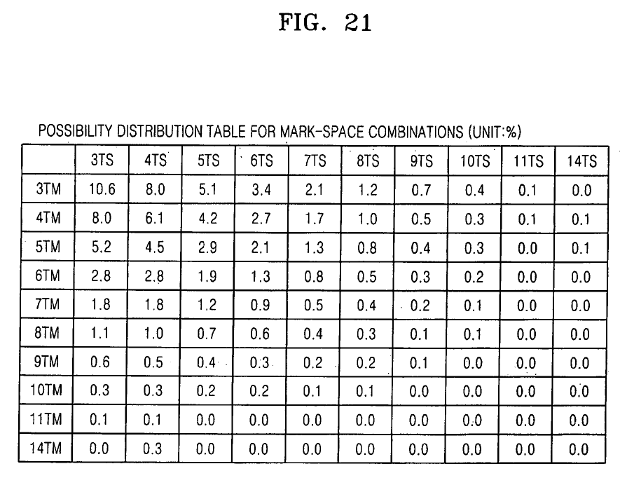

In one method of determining whether a write strategy is established using a mark-space combination, the number of samples located within a regulation range may be counted, and then it is determined whether the samples are distributed correctly. FIG. 21 illustrates a table of a probability distribution of general DVD data. Referring to FIG. 21, each combination of a mark and a space has a probability. Therefore, data is recorded by a reference write strategy, a sample ratio is measured, and then it is determined whether the sample ratio is within A±x (where A is a value read from the table of FIG. 21 and x is an allowable error).

Alternatively, instead of using the normal probability distribution illustrated in FIG. 21, recording data can be used to prepare a more reliable probability distribution table. Further, instead of considering all possible combinations of marks (3TM through 14TM) and spaces (3TS through 14TS), only the most important combinations (3T, 4T) can be used. For example, a<sample (3,3)/sample (3,4)<b and c<sample (3,3)/sample (4,3)<d are calculated, and then it can be determined that the most important data is within an acceptable range.

Next, as a method of selecting the type of four write strategies illustrated in FIG. 12 and determining the order of the write strategies, a method of selecting the type of reference write strategies and determining the order of the reference write strategies by using measured jitter from a reference write strategy recording region will be described.

For example, when the 2-edge and 3-edge write strategies are used, data is recorded by a reference write strategy and the jitter of the recorded data is measured. If the measured jitter is lower than a reference value, i.e., if the recording quality is good, only the 3-edge write strategy may be used. In contrast, if the measured jitter is higher than the reference value, the 2-edge and 3-edge write strategies may be used together (2-edge→3-edge). In addition, if the recording quality is very bad, the 1-edge, 2-edge, and 3-edge write strategies may be used in this order.

Specifically, referring to FIG. 12, a reference jitter may be set to, for example, 12%. When the jitter of recorded data by a reference write strategy is equal to or lower than the reference jitter, only the 3-edge write strategy may be used. If the jitter of recorded data is higher than the reference jitter, the 2-edge and 3-edge write strategies may be used together (2-edge→3-edge). That is, after data is recorded by the reference write strategy, it is determined whether only the 3-edge write strategy is used or the 2-edge and 3-edge write strategies are used together (2-edge→3-edge) based on the recorded quality by the reference write strategy. Therefore, an effective and stable write strategy can be established. Although the jitter graph of FIG. 12 is obtained from all marks and spaces, a D2C jitter graph obtained from combinations of the important mark 3TM and space 3TS may be used.

Next, as a method of selecting the type of four write strategies illustrated in FIG. 12 and determining the order of the reference write strategies, a method of selecting the type of reference write strategies and determining the order of the reference write strategies based on deviations measured from a reference write strategy recording region will be described.

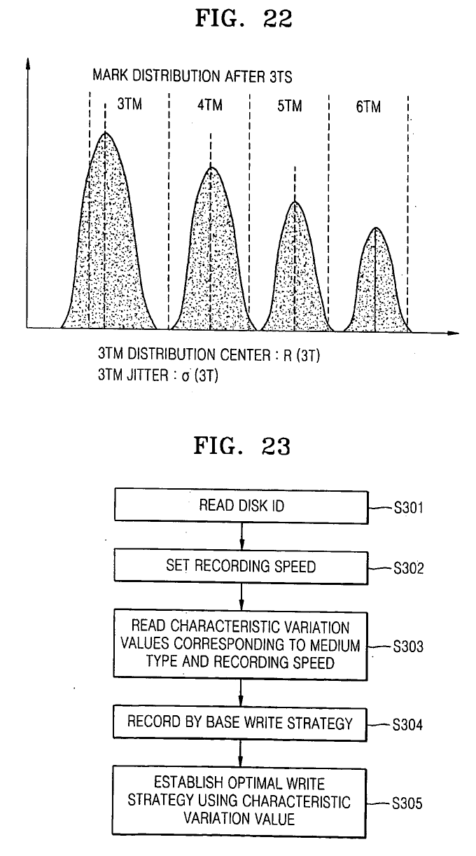

FIG. 22 illustrates distributions of marks located after 3TS. Referring to FIG. 22, a deviation value, i.e., the difference between a theoretical value and a center value of the mark distribution, may be calculated for each mark-space combination and space-mark combination. When the deviation value is large, it is determined that a portion of the mark distribution enters a neighboring regulation range, i.e., regulation window. In this case, the 1-edge or 2-edge write strategy may be used prior to the 3-edge write strategy.

In addition to determining using the deviation value, it can be determined whether └deviation±3× jitter┘ is within a regulation window. In this case, more precise determination can be implemented. Furthermore, referring to FIG. 22, it can be determined whether R(3T)±ρ(3T) is within a regulation window.

Although └sample ratio┘, └jitter value┘, and └deviation┘ are individually described, these can be used in combination with one another for more precise selection and determination of the write strategies.

Characteristic variation values (mark or space length variation per recording pulse) may be stored in the ROM 6 for various types of optical disks, a wide range of recording speeds, and RF signal equalizer settings to automatically establish an optimal write strategy. This method will now be described in more detail.

FIG. 23 illustrates a flowchart for establishing an optimal write strategy using characteristic variation values stored in the ROM 6.

In operation S 301, the controlling unit 9 may read disk identification (ID) from an optical disk. In operation S 302, the controlling unit 9 may set the data recording speed. In operation S 303, the controlling unit 9 may read characteristic variation values corresponding to the optical disk type and the data recording speed from the ROM 6. In operation S 304, the controlling unit 9 may perform test recording on a test region of the optical disk according to a reference write strategy. In operation S 305, an optimal write strategy may be established using the result of test recording and the characteristic variation values read from the ROM 6.

Meanwhile, in the conventional method, characteristic variation values of an optical disk are measured each time, and a write strategy is established using the measured characteristic variation values. In the case of embodiments of the present invention, a precise write strategy may be established if the fact that thermal interference (described later) arises when data is recorded at a high speed is ignored. However, the conventional method has the following additional problems.

First, data should be recorded at least twice using different write strategies and reproduced to calculate deviation values. Furthermore, since a write strategy compensation value W is calculated by equation W=D1/{(D2−D1)/(S2−S1)}, measurement errors are reflected in both numerator and denominator and thus the influence of the measurement errors increase.

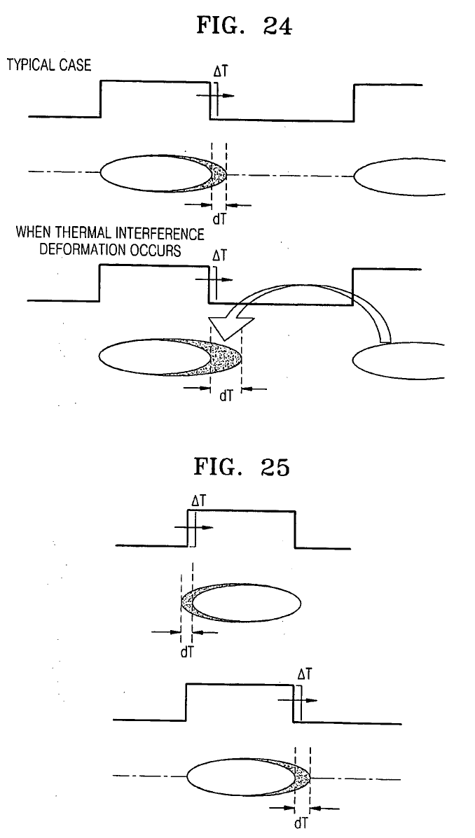

Second, when thermal interference occurs as illustrated in FIG. 24, a wrong write strategy may be established.

Third, since test data should be recorded at least twice, a lot of optical disk space may be used and a long time is needed to record the test data.

However, according to embodiments of the present invention, characteristic variation values a(m,n) may be previously stored in ROM 6. Therefore, the present invention has the following advantages when compared with the disadvantages noted above of the conventional method.

First, since a compensation value is calculated by W=D1/a (where D1 is a measured value and “a” is a stored value), measurement errors are reflected only in the numerator. Thus, the influence of the measurement errors decrease.

Second, deformation by thermal interference is rare, so ignoring thermal interference in accordance with embodiments of the present invention is rarely detrimental.

Third, since an optimal write strategy may be established by one-time recording of test data, embodiments of the present invention may use less optical disk space and may take less time to establish the optimal write strategy.

Meanwhile, when the characteristic variation values are stored in the ROM 6, the following problems may arise. First, since an optimal write strategy is established for each type of optical disk using store characteristic variation values, characteristic variation values should be previously stored for all types of optical disks. Therefore, when data is recorded in an optical disk of which characteristic variation values are not stored, an optimal write strategy cannot be established. Second, since characteristic variation values should be stored in the ROM 6 for all types of optical disks, the ROM 6 should have a large storage capacity.

However, when characteristic variation values are measured from various disks at a wide range of recording speeds, the following results can be obtained. FIG. 25 illustrates the case where the leading and trailing edges of a recording pulse are shifted for each type of mark and then the edges of the corresponding mark are measured. In FIG. 25, a characteristic variation value (a) is calculated by a=dT/ΔT.

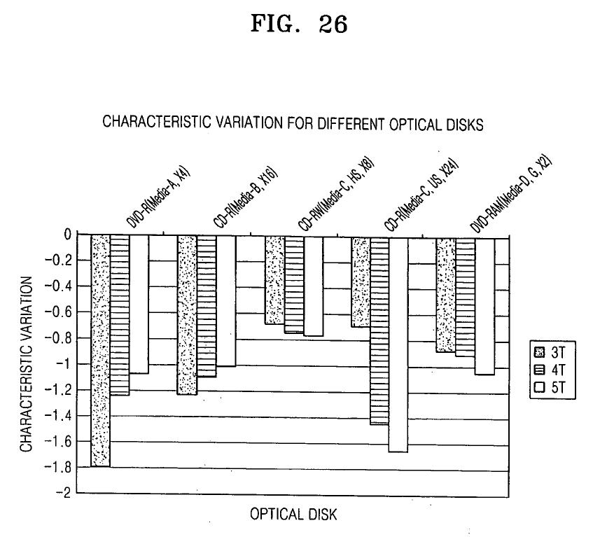

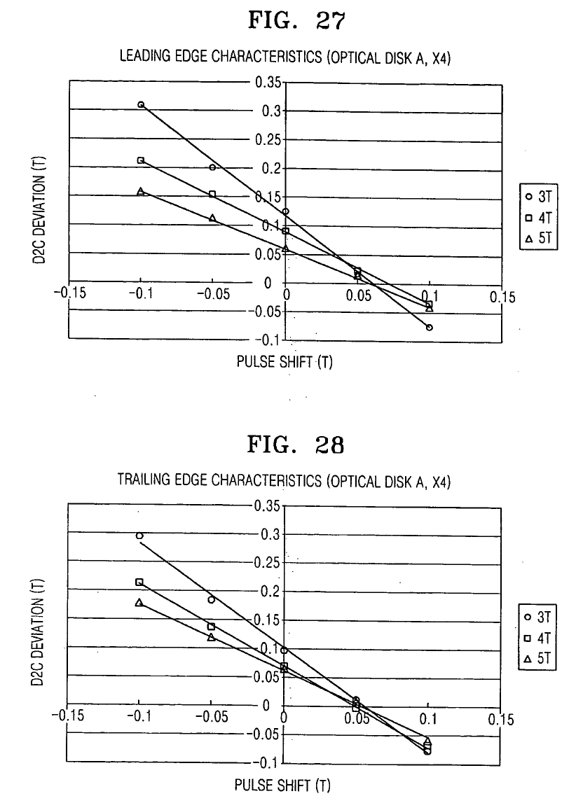

FIG. 26 illustrates 3T, 4T, and 5T characteristic variation values of various types of optical disks for a wide range of recording speeds. Referring to FIG. 26, different optical disks have different 3T, 4T, and 5T characteristic variation values. FIGS. 27 and 28 illustrate characteristic variations of the leading edge and the trailing edge, respectively, of a reproducing pulse when data is recorded at a recording speed of ×4 on DVD-R, here, an optical disk A made by company A. The characteristic variation values correspond to slopes of curves. As illustrated, when a recording pulse is changed, the length of a mark is changed at both leading and trailing edges.

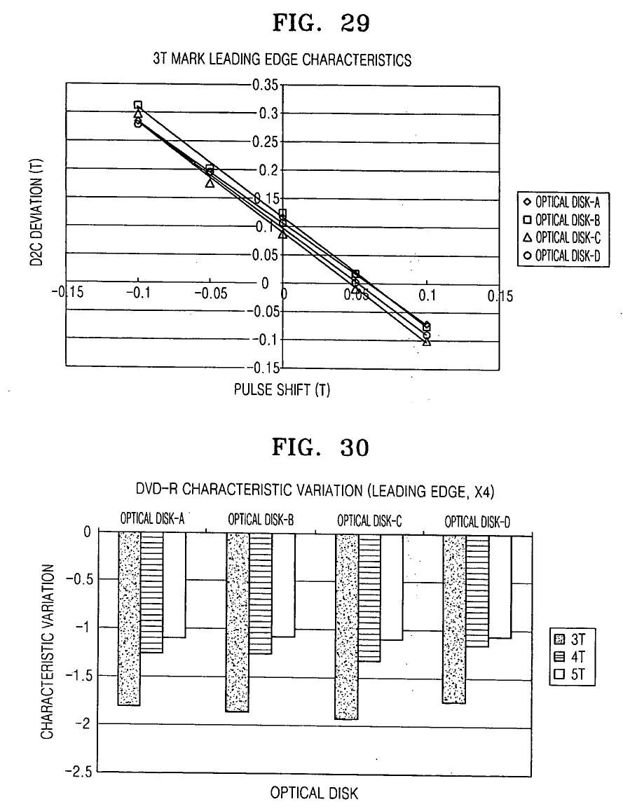

FIG. 29 compares characteristic variation values when data is recorded at a recording speed of ×4 speed on optical disks A, B, C, and D made by different manufacturers. FIG. 30 compares 3T, 4T, and 5T characteristic variation values when data is recorded at a recording speed of x4 on the same optical disks as in FIG. 29. Referring to FIGS. 29 and 30, when the disk type and the recording speed are not changed, the characteristic variation values are not substantially changed from manufacturer to manufacturer.

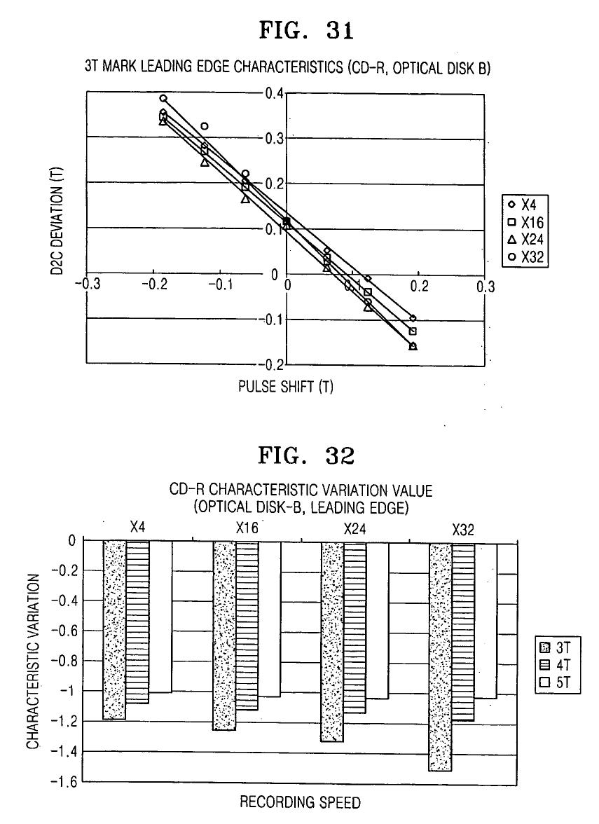

FIGS. 31 and 32 compare characteristic variations when data is recorded on the optical disk B (CD-R) at recording speeds of ×4, ×16, ×24, and ×32. Referring to FIGS. 31 and 32, the characteristic values of the same type optical disk may be changed depending on the recording speed.

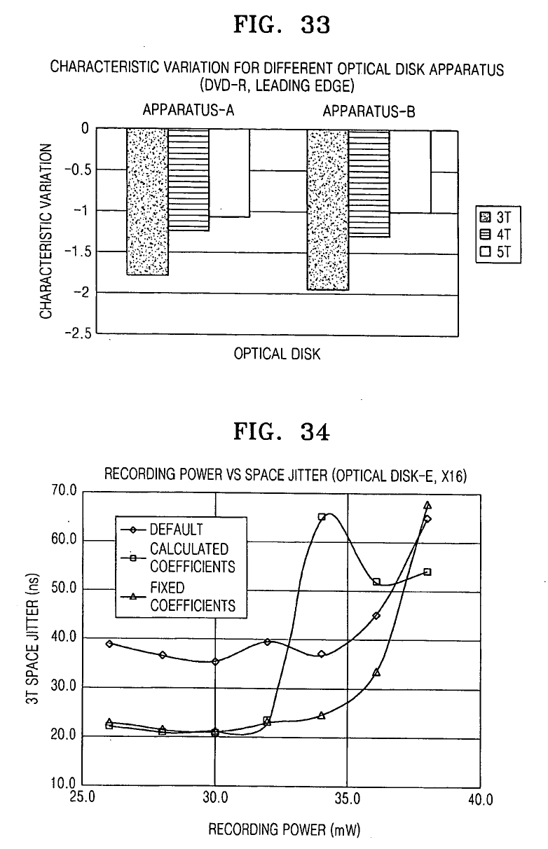

FIG. 33 compares leading-edge characteristic variation values of an optical disk (DVD-R) when the optical disk (DVD-R) is read by different optical disk apparatuses. Different optical disk apparatuses may have different RF equalizer settings. As illustrated in FIG. 33, when compensation values for an RF equalizer setting signal are different, the characteristic variation values change.

From the results illustrated in FIGS. 26 through 33, it can be understood that characteristic variation values can be adjusted for different optical disks (e.g., DVD-R, CD-R, CD-RW(HS), DVD-RAM), recording speeds, and RF signal compensation settings, so that the same characteristic variation values can be used for different optical disks, recording speeds, and RF signal compensation settings regardless of the manufacturer or media ID of the optical disk.

Furthermore, like a CD-R, when disk code settings vary depending on the dye used, the dye type can be included in the adjustment list for the characteristic variation value. Furthermore, a wide recording speed range such as x1 to x4 or x5 to x10 can be used instead of a narrow recording speed range such as x1, x2, and x3.

By storing characteristic variation values of different types of optical disks, an optimal write strategy can be established for each optical disk when the type of the optical disk and the recording speed for the optical disk are known. Furthermore, since it is not necessary to store characteristic variation values for each media ID, memory space can be saved.

FIG. 34 illustrates space jitter as a function of recording power for a CD-R (an optical disk-E) when data is recorded at a constant recording speed of x16 and a write strategy is automatically established with respect to the variation of the recording power. A default-strategy jitter curve varies largely at about 32 mW due to deformation by thermal interference. As illustrated in FIG. 34, when characteristic variation values calculated from measured results are used, jitter increases steeply after 32 mW owing to an incorrect write strategy.

On the other hand, when the characteristic variation values are fixed, recording may be performed normally at least to 35 mW. Therefore, when characteristic variation values previously stored in a memory are used, stable recording can be possible despite thermal interference deformation at a high recording speed. Furthermore, since the recording power at which thermal interference deformation occurs largely depends on the type of optical disk, using fixed characteristic variation values may increase recording quality and stability.

When a write strategy is automatically established in consideration of a neighboring edge as well as an edge of interest, the influence of the neighboring edge may be considered only when a short mark or space (a short signal) is interposed between the edge of interest and the neighboring edge. This will now be more fully described.

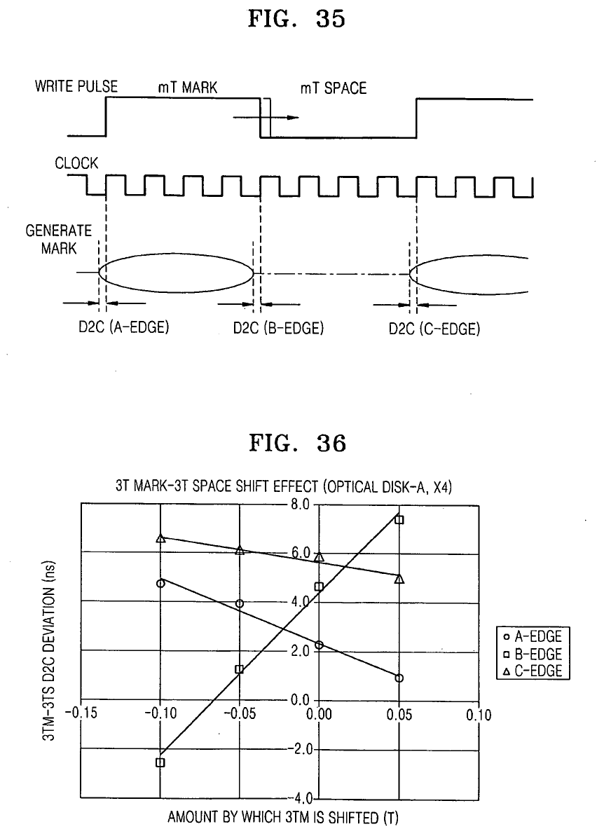

Referring to FIG. 35, an edge interposed in a mT mark-mT space combination may be shifted by a predetermined length. Then D2C deviation values of the leading edge A of a resulting mT mark, the trailing edge B of the resulting mT mark, and the trailing edge C of a resulting mT space may be measured. FIGS. 36 through 38 illustrates the relationship between the amount by which the edge of the recording pulse is shifted and the measured D2C deviation values.

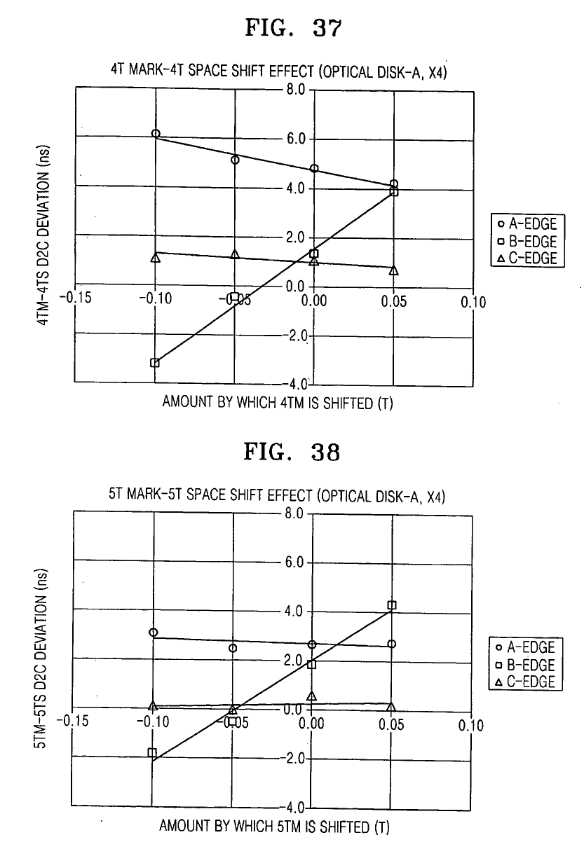

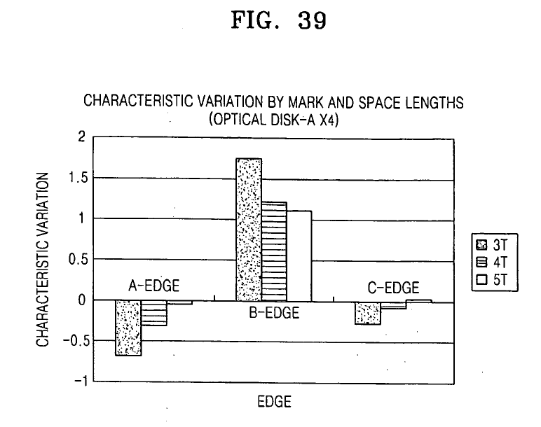

FIG. 36 illustrates the case where data is recorded at a ×4 recording speed on a DVD-R using a 3T mark-3Tspace combination pulse signal, FIG. 37 illustrates the case of a 4T mark-4T space combination, and FIG. 38 illustrates the case of a 5T mark-5T space combination. FIG. 39 illustrates a bar graph obtained by calculating slopes of the linear approximation of the curves of FIGS. 36, 37, and 38, and dividing the slopes by 1T. As illustrated, effects of the neighboring edges (edge A and edge C) may be considered only when a short signal (e.g., 3T and 4T mark signals) is disposed between the edge of interest (edge B) and its neighboring edges.

An optimal write strategy can be established using the matrix Equations 4 and 6. Here, the effects from neighboring edges can be considered only about 3T (and 4T) to reduce values in the coefficient matrix. That is, when adjusting both edges of a mark, RL₄(RL₅) through RL₁₄ and FT₄(FT₅) through FT₁₄ can be set to zero in equation 1. Furthermore, where adjusting a mark-space combination, p(m, n), q(m, n) that are not related to 3T(4T) can be set to zero. In this case, memory space can be saved when the coefficients are stored in a memory, e.g., ROM 6. Furthermore, when the coefficients are calculated from measured values, the calculating time can be reduced.

According to the present invention, deviation values of the rising and falling edges of a mark may be simply obtained from a theoretical length of the mark, so that a high-precision write strategy may be rapidly established even for high speed recording and/or short signal recording.

Exemplary embodiments of the present invention have been disclosed herein, and although specific terms are employed, they are used and are to be interpreted in a generic and descriptive sense only and not for purpose of limitation. While embodiments of the present invention have been described relative to a hardware implementation, the processing of present invention may be implemented in software, e.g., by an article of manufacture having a machine-accessible medium including data that, when accessed by a machine, cause the machine to determine optimum write strategies for the optical disk recording apparatus. Accordingly, it will be understood by those of ordinary skill in the art that various changes in form and details may be made without departing from the spirit and scope of the present invention as set forth in the following claims.

What is claimed is:

1. An optical data recording apparatus for recording data in an optical recording medium by forming rows of marks and spaces on the optical recording medium by generating recording pulse light in accordance with a predetermined write strategy and irradiating the recording pulse light to the optical recording medium, the optical data recording apparatus comprising:
a test data recording unit recording test data including marks and spaces in the optical recording medium according to the predetermined write strategy;
a reproduction signal generating unit reading the test data from the optical recording medium and generating a reproducing signal having mark pulses and spaces pulses corresponding to the marks and the spaces;
a clock signal generating unit producing a clock signal having a predetermined frequency;
a detecting unit detecting deviation values between edge timing of the reproducing signal and the clock signal for edges of the respective marks of the reproducing signal; and
a compensation unit compensating for the predetermined write strategy for each of the marks in order to adjust the deviation values to the same value.

2. The optical data recording apparatus as claimed in claim 1, further comprising a storing unit storing a characteristic variation value of each edge of the marks, the characteristic variation value being a difference value between an edge of a reproducing signal obtained by reading test data recorded by an established write strategy and a corresponding edge of the reproducing signal obtained by reading the test data recorded by the predetermined write strategy, the established write strategy being prepared for slightly changing the edge timing of each mark pulse of the reproducing signal over the predetermined write strategy,
wherein the compensation unit determines a compensation amount for the predetermined write strategy based on the characteristic variation value.

3. The optical data recording apparatus as claimed in claim 2, wherein the characteristic variation value is stored in the storing unit in accordance with a optical recording medium type, a recording speed, and an RF signal compensation setting.

4. The optical data recording apparatus as claimed in claim 2, wherein the characteristic variation value comprises:
a timing variation value of the edge of the reproducing signal obtained by reading the test data recorded by the established write strategy; and
a timing variation value of a neighboring edge spaced from the edge with a mark interposed therebetween.

5. The optical data recording apparatus as claimed in claim 4, wherein the characteristic variation value comprises both the timing variation values of the edge and the neighboring edge when a short signal is interposed between the edge and the neighboring edge.

6. The optical data recording apparatus as claimed in claim 4, wherein the reproducing signal generated from the test data recorded by the predetermined write strategy is evaluated to measure a recording quality, and write strategies and an order of the write strategies are determined based on the recording quality.

7. The optical data recording apparatus as claimed in claim 6, wherein the recording quality by the predetermined write strategy is evaluated using at least one of a sample ratio, a jitter value, and a deviation value of the reproducing signal reproduced by the reproduction signal generating unit.

8. The optical data recording apparatus as claimed in claim 2, wherein the characteristic variation value is defined for each mark-space combination, and comprises:
a first timing variation value of the edge of the reproducing signal obtained by reading the test data recorded by the established write strategy;
a second timing variation value of a neighboring edge spaced apart from the edge with a mark interposed therebetween; and
a third timing variation value of a neighboring edge spaced apart from the edge with a space interposed therebetween.

9. The optical data recording apparatus as claimed in claim 8, wherein the characteristic variation value comprises all the three timing variation values when a short signal is interposed between the edge and a neighboring edge.

10. The optical data recording apparatus as claimed in claim 8, wherein the reproducing signal generated from the test data recorded by the predetermined write strategy is evaluated to measure a recording quality, and write strategies and an order of the write strategies are determined based on the recording quality.

11. The optical data recording apparatus as claimed in claim 10, wherein the recording quality by the predetermined write strategy is evaluated using at least one of a sample ratio, a jitter value, and a deviation value of the reproducing signal reproduced by the reproduction signal generating unit.

12. The optical data recording apparatus as claimed in claim 10, wherein if the recording quality of the predetermined write strategy is acceptable, the predetermined write strategy is compensated for based on the characteristic variation value including the first and second timing variation values, and
if the recording quality is not acceptable, the predetermined write strategy is compensated for based on the characteristic variation value including the first and second timing variation values, and then the predetermined write strategy is compensated for based on the characteristic variation value including the first, second and third timing variation values.

13. The optical data recording apparatus as claimed in claim 1, wherein the test data recording unit establishes a write strategy over the predetermined write strategy for slightly changing the edge timing of each mark pulse of the reproducing signal and records test data according to the established write strategy, and
the compensation unit calculates a characteristic variation value defined as a difference value between an edge of a reproducing signal obtained by reading the test data recorded by the established write strategy and a corresponding edge of the reproducing signal obtained by reading the test data recorded by the predetermined write strategy, and determines a compensation amount for the predetermined write strategy based on the characteristic variation value.

14. The optical data recording apparatus as claimed in claim 13, wherein the characteristic variation value is defined for each mark-space combination and comprises:
a first timing variation value of the edge of the reproducing signal obtained by reading the test data recorded by the established write strategy;
a second timing variation value of a neighboring edge spaced apart from the edge with a mark interposed therebetween; and
a third timing variation value of a neighboring edge spaced apart from the edge with a space interposed therebetween.

15. The optical data recording apparatus as claimed in claim 14, wherein the characteristic variation value comprises all the three timing variation values when a short signal is interposed between the edge and a neighboring edge.

16. The optical data recording apparatus as claimed in claim 14, wherein the reproducing signal generated from the test data recorded by the predetermined write strategy is evaluated to measure a recording quality, and write strategies and an order of the write strategies are determined based on the recording quality.

17. The optical data recording apparatus as claimed in claim 16, wherein the recording quality by the predetermined write strategy is evaluated using at least one of a sample ratio, a jitter value, and a deviation value of the reproducing signal reproduced by the reproduction signal generating unit.

18. The optical data recording apparatus as claimed in claim 16, wherein if the recording quality of the predetermined write strategy is acceptable, the predetermined write strategy is compensated for based on the characteristic variation value including the first and second timing variation values, and
if the recording quality is not acceptable, the predetermined write strategy is compensated for based on the characteristic variation value including the first and second timing variation values, and then the predetermined write strategy is compensated for based on the characteristic variation value including the first, second and third timing variation values.

19. A method of optically recording data in an optical recording medium by forming rows of marks and spaces on the optical recording medium by generating recording pulse light in accordance with a predetermined write strategy and irradiating the recording pulse light to the optical recording medium, the method comprising:
recording test data including marks and spaces in the optical recording medium according to the predetermined write strategy;
reading the test data from the optical recording medium and generating a binary reproducing signal having mark pulses and spaces pulses corresponding to the marks and the spaces;
producing a clock signal having a predetermined frequency;
detecting deviation values between edge timing of the reproducing signal and the clock signal for determining edges of the respective marks of the reproducing signal; and
compensating for the predetermined write strategy for each of the marks to adjust the deviation values so as to equal the same value.

20. An article of manufacture having a machine-accessible medium including data that, when accessed by a machine, cause the machine to perform a method of optically recording data in an optical recording medium by generating recording pulse light in accordance with a predetermined write strategy and irradiating the recording pulse light to the optical recording medium, the method comprising:
recording test data including marks and spaces in the optical recording medium according to the predetermined write strategy;
reading the test data from the optical recording medium and generating a binary reproducing signal having mark pulses and spaces pulses corresponding to the marks and the spaces;
producing a clock signal having a predetermined frequency;
detecting deviation values between edge timing of the reproducing signal and the clock signal for determining edges of the respective marks of the reproducing signal; and
compensating for the predetermined write strategy for each of the marks to adjust the deviation values so as to equal the same value.
